(19) United States
(12) Patent Application Publication
(10) Pub. No.: US 2006/0172580 A1
(43) Pub. Date: Aug. 3, 2006

(54) Electrical plug connector

(76) Inventors: Johann Scholler, Deggendorf (DE); Sonja Fredl, Deggendorf (DE)

Correspondence Address: BACHMAN & LAPOINTE, P.C., 900 CHAPEL STREET, SUITE 1201, NEW HAVEN, CT, 06510, US

(21) Appl. No.: 11/181,571

(22) Filed: Jul. 14, 2005

(30) Foreign Application Priority Data
Jul. 14, 2004 (EP) 04 016 528.4

(51) Int. Cl. H01R 4/38

(52) U.S. Cl. 439/321

(57) ABSTRACT

An electrical plug connector comprises a simple and inexpensive rotation-securing element for the union nut of a water-tight plug connection which ensures reliable connection in the event of shocks and vibration, and in the process produces different values for the tightening torque and loosening torque of the screwed connection. The plug connector has a threaded union nut which is screwed to its plug housing and is secured against unintentional rotation with respect to the housing by two mutually engaging locking toothed rings having an asymmetric, sinusoidal toothed profile. The locking toothed ring which is attached to a fixing ring for the union nut is segmented, is elastically sprung and contains additional latching elements for preferred positions of the union nut.

### BACKGROUND OF THE INVENTION

The invention relates to an electrical plug connector, in which the body of at least one male connector part has a union nut which can be screwed to an associated mating connector part, said union nut being secured against unintentional rotation with respect to the body by latching means, with one of the latching means in each case being integrally formed on the body, and the corresponding other latching means being arranged on the union nut, and one of the latching means being in the form of a circumferential locking toothed ring.

In order to secure the plug connection of two plug connectors which are connected to one another, it is known to mount a union nut on one of the two connector parts such that it can rotate, said union nut being screwed to a thread provided on the connector mating piece, after which the plug connection is made. Such prevention of rotation makes assembly work easier when installing electrical systems in which a large number of plug connections have to be made many times. Such prevention of rotation is particularly important in the case of water-tight plug connections which have a sealing ring which can be clamped in place by tightening the union nut. This type of securing is also permanent, provided that the plug connection is not exposed to any movements or only exposed to slight and/or slow movements. However, if the plug connection is subject to a large number of, in particular, periodic shocks and/or a shaking movement, there is a high risk of the screwing means coming loose, so that the purpose of the union nut is no longer served and satisfactory contact is no longer ensured.

DE 43 01 504 A1 discloses an electrical plug connector of this generic type, in which a plurality of axially aligned latching webs, which are distributed over the circumference, are integrally formed on the body of the male connector part as latching means and engage in the locking toothed ring of a plastic ring which is latched to the union nut. The rear end of the union nut is provided with an inner annular groove into which the plastic ring is pressed, the locking toothed ring being integrally formed on the inner circumferential surface of said plastic ring. The plastic ring is provided with rotation stops which are accommodated in retaining recesses in the union nut. Identical values for the tightening torque and loosening torque are produced by the symmetrical configuration of the flanks of the latching elements.

DE 91 05 436 U1 also discloses a plug connector with rotation-securing means for the union nut, in which the union nut which is fitted to a male connector part latches as far as the end position on the mating connector part only after it has been screwed on. When assembling relatively large systems, the union nuts are usually first screwed onto the mating piece by the fitters by only a few turns, and then fully tightened later on. The union nuts should be secured against unintentional rotation and against falling off again in these intermediate positions too.

The object of the invention is to provide a rotation-securing means for the union nut in electrical plug connectors, which is inexpensive to produce and assemble and which can also be used in water-tight plug connections.

### SUMMARY OF THE INVENTION

The object is achieved by an electrical plug connector according to the invention which comprises a bipartite plug housing and a union nut which is mounted on said housing such that it can rotate. The plug housing is formed by a round housing and a fixing ring which is firmly connected to said round housing and prevents the union nut from falling out. The positions of the union nut and fixing ring in the axial direction are expediently fixed by circumferential collars which are attached to the round housing and act as stops. On its end face pointing in the direction of the union nut, the fixing ring has a multiplicity of protruding, axially aligned spring arms. These are uniformly distributed over the entire circumference and are sprung in the radial direction. The round housing is made of metal and effectively shields the plug connection against interfering electromagnetic, radiated emissions and external radiation, and thus ensures compliance with the existing EMC directives. In one advantageous embodiment, the fixing ring is made of plastic, and the spring arms which protrude from its front face are directly integrally formed. This ensures a cost-effective production process. In principle, it is also possible to use other elastic materials, if their spring properties are good enough. A bipartite design made of different materials is also feasible.

The spring arms which protrude from the fixing ring engage in the locking toothed ring which is integrally formed on the union nut. For this purpose, the free ends of the spring arms have, on the outer circumference of the spring arms, an axially aligned toothed profile which is designed to correspond to the toothed profile of the union nut. When the union nut is turned, the toothed profiles slide on one another and result in the union nut being constrained in a progressive, periodically changing manner, which can be sensed as a result of said union nut latching-in.

In one further advantageous refinement, the spring arms are additionally supported against the round housing in the region of the toothed profile by an additional spring element, preferably an O-ring. This measure means that greater force has to be applied in order to rotate the union nut and latching is made harder. The contact pressure in the circumferential locking toothed ring is therefore increased by means of the spring force of the O-ring and protection against unintentional loosening due to vibration is thus considerably improved.

In order to reliably fulfill is function, the O-ring is arranged precisely beneath the toothed profile and must not change its axial position, even when the union nut is turned or as a result of the union nut being turned. To this end, preferably at the corresponding location, the round housing has a circumferential groove in which the O-ring is mounted in a precise and stable position. This refinement also proves to be expedient when assembling the plug connector since the O-ring can be fitted in a simple and reliable manner.

The toothed profile of the fixing ring has a corrugated casing surface. In this advantageous embodiment, the union nut can be rotated in the loosening and tightening directions uniformly and smoothly, without application of excessive force, and in the process remains stable in defined preferred positions. Different latching torques are achieved by varying the shape, height, length and flank design of the corrugated profile. The casing surface can preferably be sinusoidal or trapezoidal. Different values for the tightening torque and the loosening torque of the screwed connection are achieved by asymmetric configuration of the rising flanks of the profile.

An internal thread, which has a plurality of turns and by means of which the plug connector is screwed to a mating connector part, is integrally formed in the union nut on the side associated with the mating connector part. In order to simplify insertion and locking of the plug connector, the internal thread is segmented. In this way, the union nut can be easily inserted into the mating connector part as far as the end position when the corresponding mating thread has a matching configuration, and can be firmly tightened by means of all of the turns of the thread by a slight turning movement. In this case, locking is possible even with a minimal axial engagement depth in the mating connector.

The union nut preferably has a locking toothed ring, which is open toward the corresponding end face, on the inner circumference of the side facing the fixing ring. This preferred refinement means it is possible to reduce production costs for the injection-molding dies and increase their process reliability.

The locking toothed ring of the union nut preferably has a corrugated toothed profile. Obviously, different embodiments which are similar to the toothed profile of the fixing ring and have the corresponding features are also feasible here. It has proven advantageous for the two mutually engaging toothed profiles to be of corresponding, that is to say mirror-image-inverted, form, with the combination of different corrugated forms also not being excluded.

The fixing ring and union nut advantageously have additional latching elements by means of which the union nut can be placed in preferred positions in relation to the plug housing. To this end, one or more additional toothed profiles are expediently integrally formed, offset in the axial direction, on the spring arms which protrude from the fixing ring and engage in a second locking toothed ring of the union nut. A marker provided on the fixing ring points toward the polarity-reversal protection means which is integrally formed on the round housing and is concealed by the union nut. This aid considerably simplifies insertion of the plug connector for the user. In one further advantageous embodiment, the latching position is supplemented on one side by a fixed stop and the function of a bayonet fitting is thus achieved in conjunction with the segmented internal thread of the union nut.

In summary, it can be stated that the forces which have to be applied to tighten and loosen the union nut are governed by the geometry of the toothed profile, the number and the strength of the spring arms, and the elasticity of the O-ring. Different values for the tightening torque and/or the loosening torque can be achieved by asymmetric configuration of the flanks of the toothed profile.

### BRIEF DESCRIPTION OF THE DRAWINGS

The invention is explained in greater detail below using one exemplary embodiment and with reference to the accompanying drawings, in which:

FIG. 1 shows an exploded illustration of one exemplary embodiment of the plug connector according to the invention, with a perspective view of the components;

FIG. 2 shows a longitudinal section through the middle plane of an assembled plug connector;

FIG. 3 shows a perspective view of the union nut;

FIG. 4 shows a perspective view of the plug housing with the fixing ring having a symmetrical, sinusoidal toothed profile fitted;

FIG. 5 shows a longitudinal section through a plug connector which is connected to a mating connector part;

FIG. 6 shows a perspective view of a modified plug housing having a latching element for a preferred position of the union nut and having an asymmetric, sinusoidal toothed profile;

FIG. 7 shows a detail of the locking toothed ring of the union nut having an asymmetric, sinusoidal toothed profile and additional latching studs for a preferred position of the union nut;

FIG. 8 shows a detail of the locking toothed ring of the union nut having an asymmetric, sinusoidal toothed profile, latching studs and an additional fixed stop for the union nut.

### DETAILED DESCRIPTION

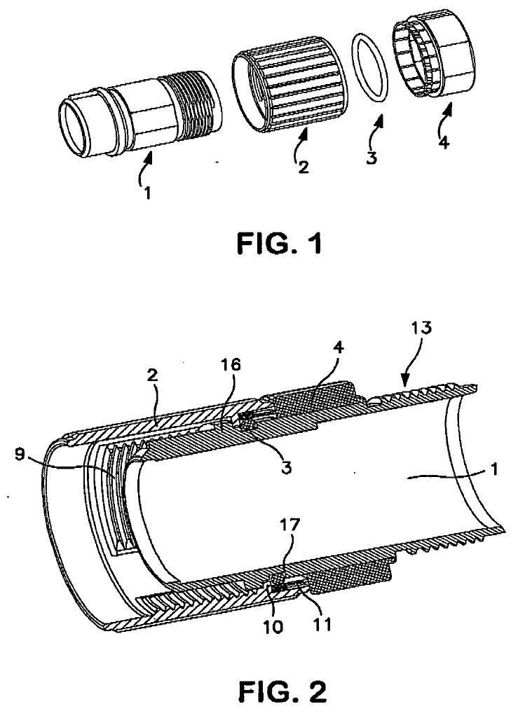

FIG. 1 shows the design of the electrical plug connector which comprises a round housing 1, a union nut 2, an O-ring 3 and a fixing ring 4. During the assembly process, first the union nut 2 and then the O-ring 3 are screwed onto the round housing 1 and secured by the fixing ring 4.

FIG. 2 shows a longitudinal section through the middle plane of an assembled plug connector. The union nut 2 is screwed onto the round housing 1 in such a way that its internal thread 9 points in the direction of the plug front, that is to say toward the mating connector part, and a radial collar 10 which is situated on the inner circumference of said union nut rests on a stop collar 16 on the round housing 1. This prevents the union nut 2 from falling out in the direction of the mating connector part. When the union nut 2 is screwed onto a mating connector part, the collar 10 acts as a driver and presses the circumferential stop collar 16 of the round housing 1 against the mating connector part. To the rear, that is to say in the direction of the threaded flange 13, the fixing ring 4 which is pressed firmly onto the round housing 1 serves as a stop for the union nut 2. The distance between the two stops is selected in such a way here that the union nut 2 can be rotated freely. The spring arms 11 protruding at the end face of the fixing ring 4 which points toward the union nut 2 engage with the locking toothed ring 8 of the union nut 2. The free ends of the spring arms 11 are additionally elastically supported in the region of the toothed profile 12 by an O-ring 3. For fixing purposes, the O-ring 3 is mounted in a circumferential groove 17 in the round housing 1.

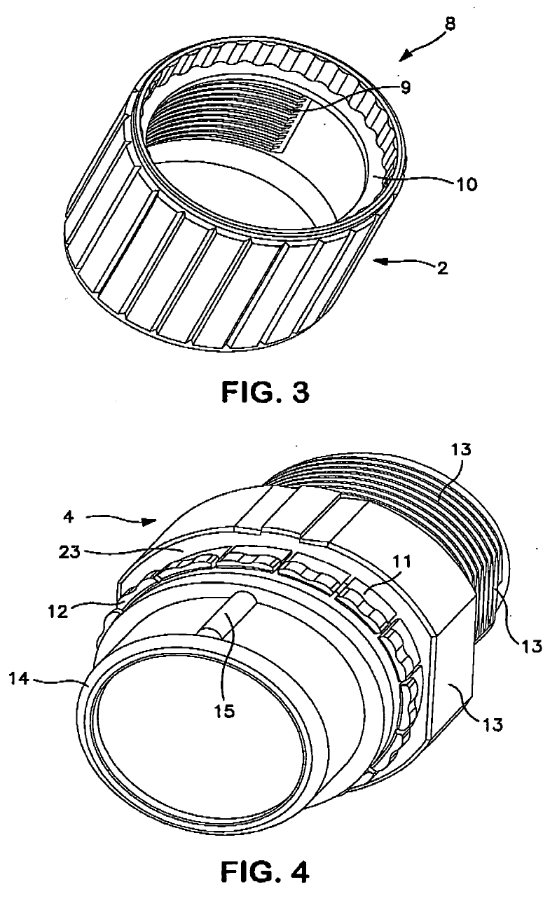

FIG. 3 shows a perspective view of the union nut. The union nut 2 is in the form of a knurled nut and, on the inner casing surface, has a circumferential collar 10, which acts as a stop for the round housing 1, on the rear side which faces the fixing ring. The internal thread 9 is illustrated at the opposite end and in this embodiment is in segmented form. The internal thread 9 comprises six identical segments, of which each alternate segment does not have a tooth system. If the thread of the mating connector part is formed in a similar manner, the plug connector can be inserted as far as the stop and can be locked by means of all of the turns of the thread by rotation through 60°. On the side opposite the threaded side, a locking toothed ring 8 is integrally formed from the collar 10 as far as the end face. The locking toothed ring 8 has a sinusoidal casing surface and is symmetrical. Smooth latching is achieved by this special design.

FIG. 4 shows a perspective view of the plug housing with the fixing ring fitted. The round housing 1 has two diametrically opposite flats 18 on its outer shell which, together with the corresponding flats 19 which are integrally formed on the inner shell of the fixing ring, reliably prevent the fixing ring from rotating. Spring arms 11, which have a toothed profile 12 at their ends and are uniformly distributed over the circumference, protrude from the front face of the fixing ring 4. The individual spring arms 11 thus constitute a segmented locking toothed ring whose individual segments are sprung. When the union nut 2 is turned, the spring arms 11 yield in the direction of the round housing 1. Furthermore, the plug connector has, on its front face, a sealing area 14 for sealing against penetrating moisture, and a lug 15 which acts as a polarity-reversal protection means.

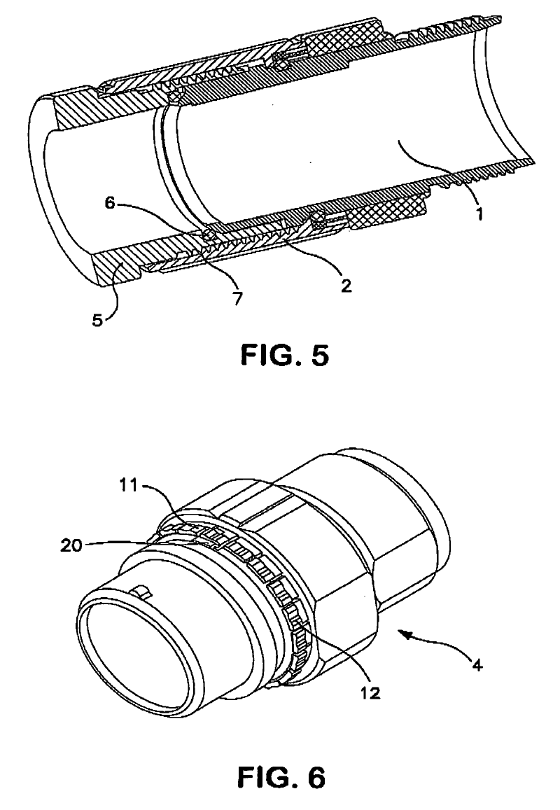

FIG. 5 shows a longitudinal section through a plug connector which is connected to a mating connector part. In order to seal it against moisture, a sealing ring 6 is mounted in a groove in the mating connector part 5 in such a way that the sealing area 14 of the round housing 1 is pressed against the sealing ring 6 when the union nut 2 is tightened.

FIG. 6 shows a perspective view of a further exemplary embodiment with a modified plug housing, preferably having a latching stud 20 for a preferred position of the union nut 2 and having a symmetric, sinusoidal toothed profile. The latching stud 20 is integrally formed on a spring arm 11 of the fixing ring 4 and is thus radially sprung.

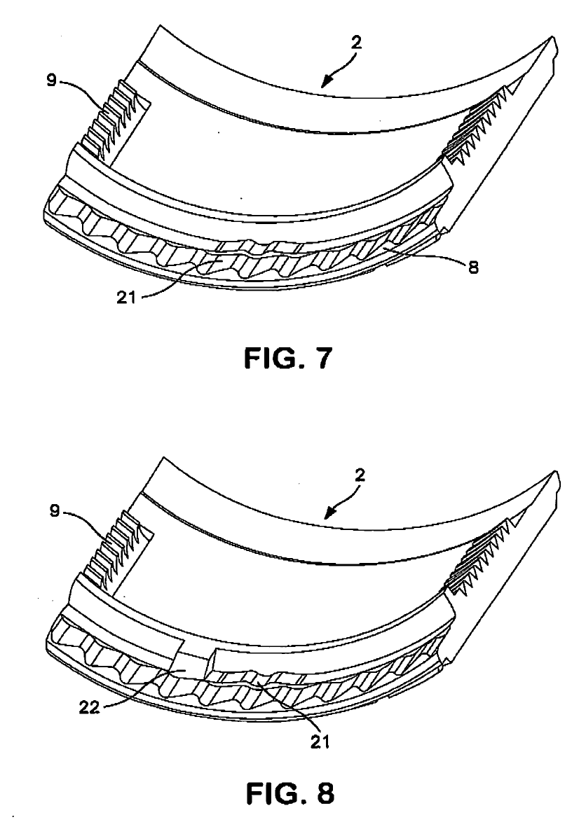

FIG. 7 shows a detail of the locking toothed ring 8 of the union nut 2 of the exemplary embodiment from FIG. 6 which has an asymmetric, sinusoidal toothed profile and an additional symmetric latching groove 21 for the preferred position of the union nut. In this preferred position, the segmented internal thread 9 of the union nut 2 is precisely positioned in relation to the round housing 1 for insertion into the mating connector part 5.

FIG. 8 shows a detail of a further variant of the locking toothed ring 8 of the union nut 2 with an integrated additional fixed stop 22. This embodiment is preferably used when the plug connector is in the form of a bayonet fitting and limits the angle of rotation of the union nut 2 when it is screwed on, so that the unlocked position of the union nut 2 and mating connector part 5 is precisely positioned and excessive turning is thus prevented.

1. An electrical plug connector, comprising body of at least one male connector part having a union nut which is screwed to an associated mating connector part, said union nut being secured against unintentional rotation with respect to the body by two latching means, wherein one of the latching means is integrally formed on the body, and the other latching means is arranged on the union nut, and wherein one of the latching means is in the form of a circumferential locking toothed ring, a bipartite plug housing comprises a round housing (1) and a fixing ring (4) which is firmly attached to said round housing, the fixing ring secures the union nut (2) and has a multiplicity of axially aligned, radially sprung spring arms (11) which protrude from an end face (23) of the fixing ring (4) and are uniformly distributed over a circumference of the fixing ring.

2. The electrical plug connector as claimed in claim 1, wherein the spring arms (11) have free ends on the circumference of an axially aligned toothed profile (12).

3. The electrical plug connector as claimed in claim 2, wherein the spring arms (11) are elastically supported in relation to the round housing (1) in the region of the toothed profile (12) by a spring element.

4. The electrical plug connector as claimed in claim 3, wherein said spring arms are supported by an O-ring (3) mounted in a circumferential groove (17) in the round housing (1).

5. The electrical plug connector as claimed in claim 4, wherein the toothed profile (12) of the fixing ring (4) has a corrugated casing surface.

6. The electrical plug connector as claimed in claim 1, wherein the union nut (2) has a segmented internal thread (9) on a side associated with the mating connector part (5).

7. The electrical plug connector as claimed in claim 6, wherein the union nut (2) has a locking toothed ring (8), which is open toward a corresponding end face, on an inner circumference of a side facing the fixing ring (4).

8. The electrical plug connector as claimed in claim 7, wherein the locking toothed ring (8) has a corrugated toothed profile.

9. The electrical plug connector as claimed in claim 1, wherein the union nut (2) is latched to the round housing (1) in at least one position.
